(19) United States
(12) Patent Application Publication
(10) Pub. No.: US 2016/0247123 A1
(43) Pub. Date: Aug. 25, 2016

(54) Converting Scheduling Information into Different Conferencing Domains

(71) Applicant: Cisco Technology, Inc., San Jose, CA (US)

(72) Inventors: Magnus Aaen Holst, Kjeller (NO); Nicolai Grødum, Oslo (NO)

(21) Appl. No.: 14/629,716

(22) Filed: Feb. 24, 2015

(51) Int. Cl. G06Q 10/10

(52) U.S. Cl. CPC G06Q 10/1095

(57) ABSTRACT

A user device that is capable of scheduling a meeting or receiving an invitation to a meeting, generates a meeting join link for a scheduled virtual meeting. A meeting calendar identifier for the scheduled virtual meeting is retrieved. A meeting join link for the scheduled virtual meeting is generated based on the meeting calendar identifier. Thereafter, the user device may user the meeting join link to join the scheduled virtual meeting. The user device connects to a server that joins/connects the user device to the scheduled virtual meeting based on the meeting join link.

### TECHNICAL FIELD

The present disclosure relates to virtual meeting services.

### BACKGROUND

Today, when a meeting organizer wants participants to attend a conference with one or more meeting resources/technologies (e.g., Telepresence, web conference (e.g., WebEx® web conferencing service, etc.), the organizer needs to book (i.e., reserve/schedule) all the meeting infrastructure and equipment resources up-front, that is, at the time the meeting is scheduled. This is currently achieved with various integration tools. These tools monitor the meeting equipment (rooms, endpoints, etc.) and connection resources used in routing media, and then reserves all the linked resources through a management system.

### BRIEF DESCRIPTION OF THE DRAWINGS

FIG. 1 is a diagram illustrating a system in which user devices can join a virtual meeting without having to distribute join link information at the time the virtual meeting is scheduled, according to an example embodiment.

FIG. 2 is a system block diagram showing a user device and a server that form part of the system depicted in FIG. 1, according to an example embodiment.

FIG. 3 is a sequence diagram for a process by which a virtual meeting is scheduled and from which a join link to the virtual meeting can be generated by a user device at any time, according to an example embodiment.

FIG. 4 is a sequence diagram for a process on a user device by which join links are generated for a scheduled virtual meeting, according to an example embodiment.

FIG. 5 is a sequence diagram for a process by which a user device joins a virtual meeting using join links generated according to the process of FIG. 4, according to an example embodiment.

FIG. 6 is a flow chart depicting operations performed by a user device in accordance with the process depicted in FIG. 4, according to an example embodiment.

FIG. 7 is a flow chart depicting operations performed by the server in accordance with the process depicted in FIG. 5, according to an example embodiment.

FIGS. 8A-8D are diagrams illustrating an example of the techniques depicted in FIGS. 1-7 for a meeting, according to an example embodiment.

### DESCRIPTION OF EXAMPLE EMBODIMENTS

### Overview

In accordance with one embodiment, in a user device that is capable of scheduling a meeting or receiving an invitation to a meeting, operations are performed to generate a meeting join link for a scheduled virtual meeting. A meeting calendar identifier for the scheduled virtual meeting is retrieved. A meeting join link for the scheduled virtual meeting is generated based on the meeting calendar identifier. Thereafter, the user device may user the meeting join link to join the scheduled virtual meeting.

In accordance with another embodiment, a server receives a communication from a user device, the communication made using a meeting join link that is associated with a scheduled virtual meeting. The meeting join link had been previously generated by the user device based on a meeting calendar identifier associated with the scheduled virtual meeting. After receiving the communication, the server determines whether the scheduled virtual meeting for the meeting join link has already been activated. If it is determined that the scheduled virtual meeting has not yet been activated, the scheduled virtual meeting is activated (started) and the user device is connected into the scheduled virtual meeting. If it is determined that the scheduled virtual meeting has already been activated, the user device is connected into the scheduled virtual meeting that has already been activated.

### Example Embodiments

According to the embodiments presented herein, the scheduling of a virtual meeting (video conference, web conference, audio conference, or any other conference technology now known or hereinafter developed) is simplified to “people scheduling people.” The meeting organizer need only schedule the meeting participants and a physical shared meeting room which may include a video conference endpoint, and not the meeting resources/services. The meeting participants can join the conference with any equipment they choose. This is not possible with current technology.

The apparatus, system, and methods presented herein allow virtual meetings to be scheduled without having to distribute additional information about the meeting resources/services to be used for the meeting. The calendar/scheduling function (responsible for when the meeting is to occur and who will participate in the meeting) is separate from the virtual conferencing domain (responsible for allowing participants to join and connect to the virtual meeting). In other words, a meeting participant can join any meeting using any equipment he/she chooses at the time of joining the meeting without the meeting organizer having to specify or schedule the meeting resource technology for the scheduled meeting.

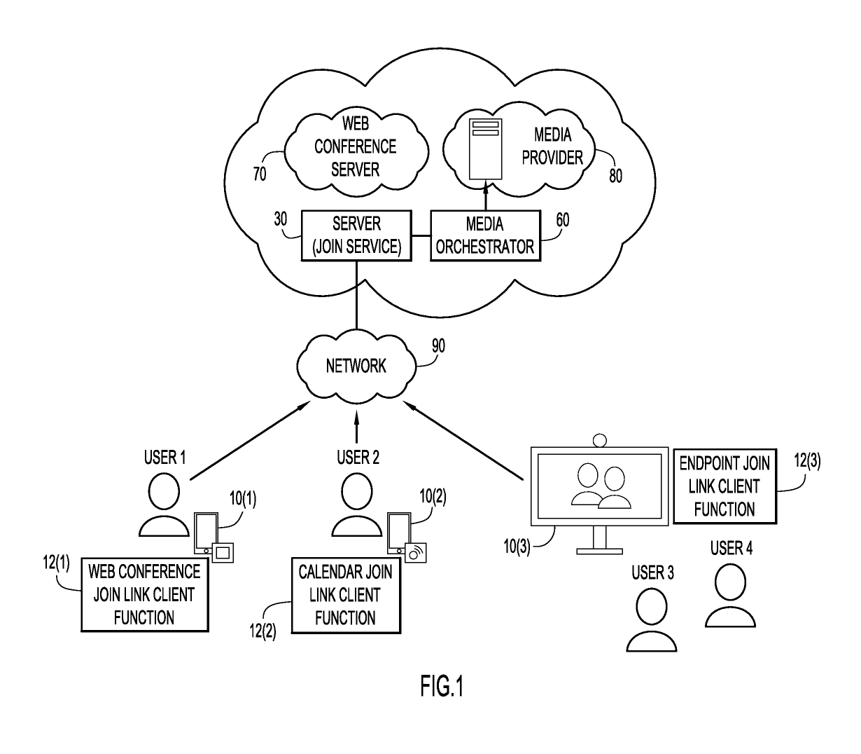

Referring first to FIG. 1, a diagram is shown of a network environment in which the apparatus, system, and methods presented herein may be deployed. At a high level, the system includes a join link client function that is provided at a calendar application on a user device. This join link client function may be embodied as plug-in software to a calendar application or may be a function integrated into the calendar application software.

FIG. 1 shows an example in which there are multiple user devices 10(1), 10(2), 10(3), each running a calendar application of some type, and associated with each calendar application there is a join link client function. The calendar application may be a stand-alone function on a user device or may be integrated into, or interfaced with, another application, such as a web conference application. The user devices can take on a variety of forms, including a SmartPhone, tablet, laptop computer, desktop computer, video conference endpoint etc. User device 10(1) runs web conference client software and has associated therewith a web conference join link client function 12(1). Similarly, user device 10(2) runs a calendar application and has a calendar join link client function 12(2). Likewise, user device 10(3) is a video conference endpoint and has an endpoint join link client function 12(3).

The user devices communicate with a server 30. The server 30 provides a join service that is brought into play at the time that a user clicks on a join link in order to join the virtual meeting.

As will become apparent hereinafter, the join link client function on a user device converts existing meeting scheduling information into a domain of the meeting resource with which the participant chooses to join the virtual meeting. The server 30 can host the meeting itself, or function as a proxy and forward requests to a virtual meeting hosting service, as will be described hereinafter.

FIG. 1 also shows that the user devices may be physical locally on premises (OP) of an enterprise or other organization, though this is not required. In addition, FIG. 1 shows that the server 30, along with a media orchestrator function 60, web conference server 70 and media provider 80 may reside off premises in a cloud or data center computing environment. This is not meant to be limiting as the server 30 may reside on premises. The media orchestrator 60 ensures that all the participants get connected to the same meeting being supported by the media provider 80, or in the case of multiple media providers, to the appropriate one or more media providers. The functions of the media orchestrator 60 and/or the media provider(s) 80 may be performed by separate entities as shown, or may be integrated into the functions performed by the server 30 (either on-premises, in the cloud, or a hybrid of on-premises and cloud). The user device 10 communicates with server 30 via a network 90. Network 90 may be any one or more of a wired or wireless local area network (LAN) and wired or wireless wide area network. The network 90 may support a variety of protocols, including without limitations, Session Initiation Protocol (SIP), Hypertext Transfer Protocol (HTTP), Real-time Transport Protocol (RTP), etc.

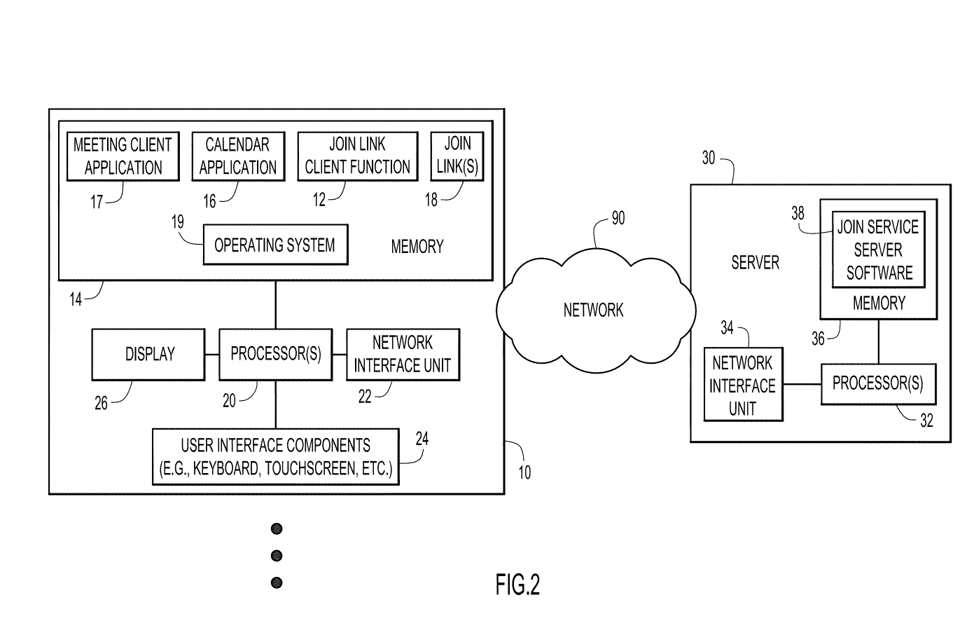

Reference is now made to FIG. 2. FIG. 2 shows a block diagram of a user device 10 having a join link client function 12, and server 30. The user device 10 and server 30 are in communication with each other via network 90.

The user device 10 may include a memory 14 storing the software instructions for the join link client function 12, along with software instructions for a calendar application 16, a meeting client application 17 (e.g., web conference client application, endpoint client application, etc., that uses, interfaces or has integrated therein functions of the calendar application), and one or more join links 18 generated by the join link client function 12. For the same of completeness, FIG. 2 also shows an operating system 19 on which the application 16 and the join link client function 12 run. The user device 10 further includes a processor 20 (e.g., a microprocessor or microcontroller), a network interface unit 22 that enables wired and/or wireless network communication, one or more user interface components 24 (e.g., keyboard, mouse, touchscreen, etc.) and a display screen/monitor 26. Other user devices may have a similar block diagram representation as that shown for user device 10 shown in FIG. 2.

The server 30 includes one or more processors 32, a network interface unit 34 and a memory 36. The memory 36 stores instructions for join service server software 38.

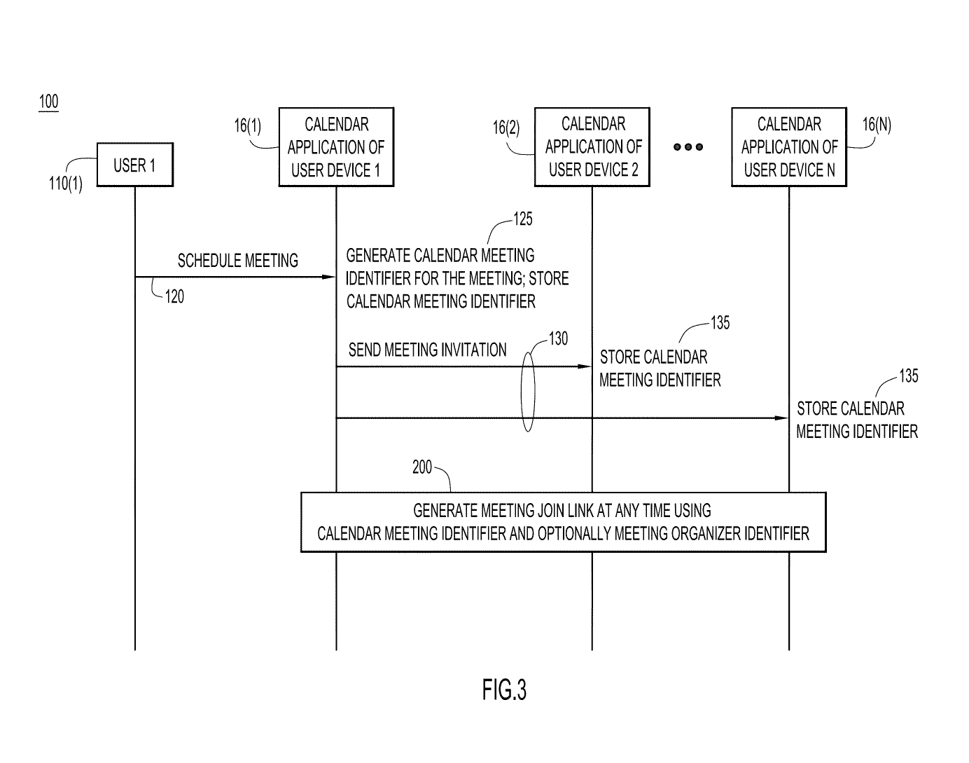

The memory 14 and memory 36 shown in FIG. 2 may include read only memory (ROM), random access memory (RAM), magnetic disk storage media devices, optical storage media devices, flash memory devices, electrical, optical, or other physical/tangible memory storage devices. Thus, in general, the memory shown in FIG. 2 may include one or more tangible (non-transitory) computer readable storage media (e.g., a memory device) encoded with software comprising computer executable instructions and when the software is executed (by the associated processor) the processor is operable or caused to perform the operations described herein in connection with FIGS. 3-7 and 8A-8D, for the user device 10 and the server 30.

Reference is now made to FIG. 3. FIG. 3 illustrates a process flow 100 when a user schedules a meeting. In this example, User 1 shown at reference numeral 110(1) schedules a meeting to which User 2-User N are invited to participate. On the user device of User 1 (User Device 1), there is a calendar application shown at reference numeral 16(1), and similarly User Device 2 has a calendar application 16(2) and User Device N has a calendar application 16(N). The calendar applications 16(1)-16(N) are capable of generating a meeting (a meeting appointment) and sending a meeting invitation to users, as well as receiving a meeting invitation. It should be understood that the functions of the calendar applications 16(1)-16(N) may be integrated as part of a meeting client application, as explained above.

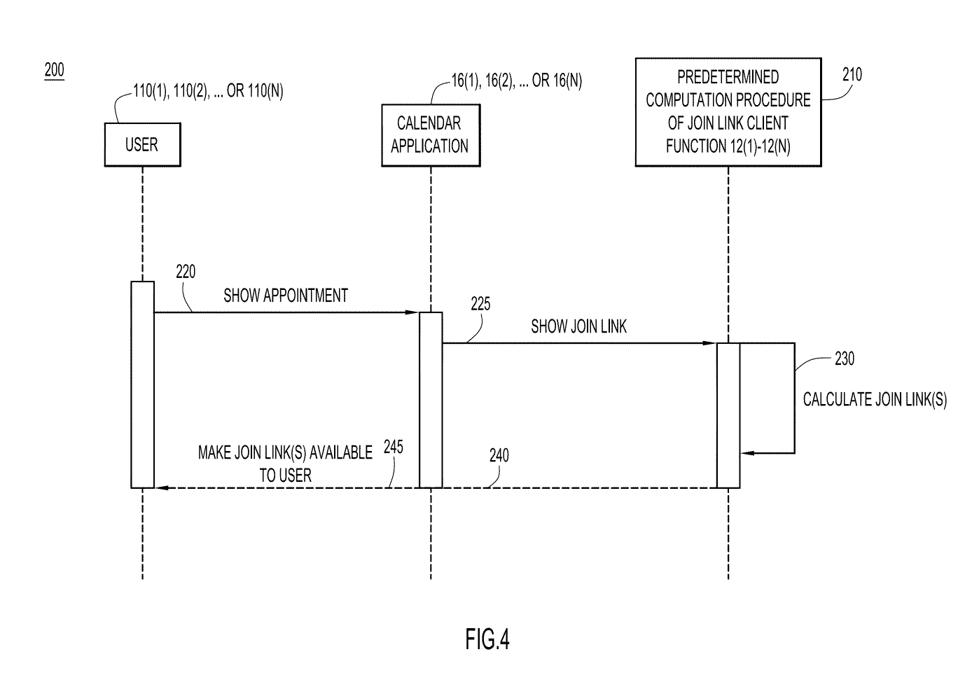

At 120, User 1 uses calendar application 16(1) to schedule a virtual meeting at a given date and time in the future, and the participants of the meeting are User 2-User N. At 125, the application 16(1) generates a calendar meeting identifier for the scheduled meeting, and stores the calendar meeting identifier. At 130, the calendar application 16(1) causes a meeting invitation to be sent to the user devices for User 2-User N. At 135, if User 2-User N accepts the invitation, the calendar applications 16(2)-16(N) will each store the calendar meeting identifier (and the meeting organizer identifier). From this point forward, as shown at reference numeral 200, the user devices for User 1-User N can generate a meeting join link at any time using the calendar meeting identifier (and optionally the meeting organizer identifier) for the scheduled virtual meeting. The process 200 for generating the meeting join link is described below in connection with FIG. 4.

The meeting calendar identifier may be any identifier that is unique to the scheduled meeting. In one example, the calendar (or other similar) application that is used to schedule a meeting generates the meeting calendar identifier that is compliant with the Internet Calendaring and Scheduling Core Object Specification (iCalendar) of RFC 5545, or any other suitable format that is common or compatible with applications running across user devices.

The iCalendar (iCal) object generated for a meeting includes a universal identifier (UID), and this UID may be used as the meeting calendar identifier. An example format of an iCalendar object is provided in RFC 5545, and example format of the UID is: 19970610T172345Z-AF23B2@example.com. The iCal UID is an identifier that is distributed to all participants of a meeting in an iCal-based calendaring system (Microsoft Exchange, Office 365, Gmail, etc.). This identifier connects participant invitations, responses to a single meeting and is identical for all meeting invitees in addition to the organizer. The meeting organizer identifier may be an email address of the user that organizes (hosts) the meeting, e.g., user1@company.com.

Reference is now made to FIG. 4, which illustrates a flow for the process 200 of generating a meeting join link. The process 200 involves application of a predetermined computation procedure 210 performed by the join link client function in a user device. Examples of the predetermined computation procedure 210 are described below. At 220, any user of a user device can initiate the process 200 by making a user interface request to view/show a scheduled appointment stored by the calendar application running on that device. FIG. 4 shows that the user can be any of the users 110(1)-110(N) of FIG. 3, including User 1 who scheduled the meeting or any of User 2-User N who received and accepted the invitation to the meeting. At 225, the calendar or other application on the user device sends a request to the join link client function and at 230, a predetermined computation procedure 210 is executed by the join link client function based on at least on the meeting calendar identifier, and optionally based further on the meeting organizer identifier, to generate a join link (or multiple join links of different protocol types, as described further below) that is uniquely associated with the scheduled virtual meeting. At 240, the join link client function returns the join link(s) to the application which stores it in memory and can make it available to the user at 245.

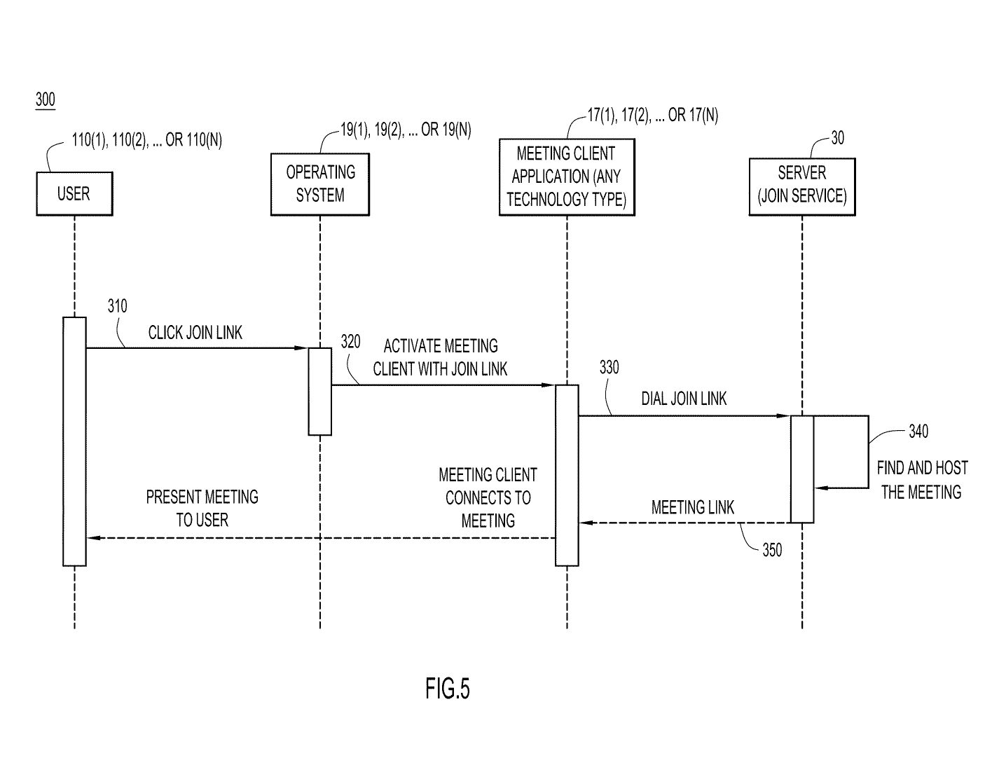

As explained above, any user device with the join link client function can generate a join link for a scheduled meeting that has been stored in the associated calendar application. For example, the join link can be generated at any time after the meeting has been scheduled by the user device that scheduled the meeting or by a user device that received and accepted the meeting invitation. It is not necessary that the join link be generated immediately upon meeting scheduling and acceptance. However, the join link needs to be generated before a user can join the meeting because the join link is used to connect to the server 30 (FIGS. 1 and 2) in order for the server to identify the meeting and join the user to that meeting. A meeting join process is described below in connection with FIG. 5.

The predetermined computation procedure 210 may take on a variety of forms and ranges of complexity. In its simplest form, the predetermined computation procedure 210 forms the join link by concatenating the UID for the meeting with the domain of the join service, e.g., UID@joinservicedomain.com. For a static global domain, the join link may be UID@meetingorganizerdomain.com. In yet another form, the meeting organizer identifier (e.g., email address is used with the UID) such the join link takes the form of UIDorganizeremailaddress@joinservicedomain.com. In general, the meeting join link is a Uniform Resource Identifier (URI) of any URI scheme including, but not limited to, a URI with a scheme for the Session Initiation Protocol (SIP), a URI with a scheme for the Hypertext Transport Protocol (HTTP), and a URI with a scheme for the Hypertext Transfer Protocol Secure (HTTPS), etc.

In one example, for a meeting resource technology that uses the SIP, the information used to generate a join link includes:

### UID: A

### Organizer B

### Delimiter: X

Service host: C
where A is the meeting calendar identifier (in iCal UID format), B is the meeting organizer identifier, C is the join service running on the server 30 as described above in connection with FIG. 1, and X is a delimiter.

The SIP dial string for these parameters would be:

sip:A′XB′@C where A′ is A transformed, and B′ is B transformed.

A transformation in the SIP domain is one that adheres to the allowed characters in a SIP dial string as defined in RFC 3261.

An example of a resulting join link (dial string) would then be: 54D7044E-E9A0-4BCC-955C-659F567C93D9%3Aorg %40company@example.com, where the properties for the example are the following values:

C=“example.com” and is the host of the join service running on server 30.

### X=“%40”

### B=“org@company”

### A=54D7044E-E9A0-4BCC-955C-659F567C93D9

The transformation performed could also be performed on the “AXB” part as a whole, where the transformation is a base64 variant. In this case, the join link (dial string) would be:

### NTRENzAONEUtRTlBMC00QkNDLTk1NUMtNjU5RjU2N0M5M0Q5Om9yZ0Bjb21wYW55 QGV4YW1wbGUuY29t@example.com

A base64 computation still contains the data within it. In still another example, the predetermined computation procedure of the join link client function performs a one-way hash (e.g., SHA hash) of the UID and meeting organizer identifier so that all join link client functions produce the same hash result.

As explained above, the meeting join link generated according to this technique could be any type of link, e.g., SIP link, web conference (e.g., WebEx link), etc. It is a dial string for a given technology domain. Once generated, the join link is saved in memory on the user device where it is generated. The join link is not intended to be human readable. That is, it is presented to a user as a clickable link or dial string that, when clicked, establishes a connection to the server 30, but it may be quite lengthy in terms of the number of characters. It is used thereafter only for clicking when a user wants to join the meeting. The join link can be calculated on-demand at any time. The calendar or other application determines when it is time to join the scheduled meeting and may generate a visual or audible alert to the user before meeting start time. If the join link has not already been generated when a user initiates to join the meeting, the join link client function will be triggered to generate the join link.

Furthermore, at operation 230 in FIG. 4, the predetermined computation procedure 210 of the join link client function may generate multiple join links for the same (any given) scheduled virtual meeting. Each of the multiple join links for a given virtual meeting may be for a different type of protocol, e.g., a first link for SIP, a second link for HTTP, a third link for HTTPS, etc. For example, the join link client function will generate 3 links (URIs) for a given scheduled virtual meeting:

1. One URI for the SIP scheme: sip:sa98dv@example.com

2. A second URI for the HTTP scheme: http://example.com/sa98dv

3. A third URI for an unknown scheme: xx:sa98dv

where “sa98dv” is the UID for the scheduled meeting identifier (UID), truncated for this example, and where the join link is generated from the UID for the meeting without the meeting organizer identifier. Thus, when generating a meeting join link for a scheduled virtual meeting, the join link client function may generate a plurality of meeting join links, each of the plurality of meeting join links associated with the scheduled virtual meeting. Moreover, each of the plurality of meeting join links is for a different communication protocol by which the scheduled virtual meeting can be joined.

This join link client function resides in every user device (meeting organizer and participant) that is capable of operating in accordance with the techniques presented herein, and all join link client functions use a common algorithm/function (predetermined computation procedure 210) that (at a minimum) uses the meeting calendar identifier (and optionally a meeting organizer identifier) as input to generate join links that point to the same meeting for the same meeting calendar identifier. As a result for any given meeting, the same join link (dial-string) will be generated by the meeting organizer's user device and the user device of every participant invited to the meeting. The meeting organizer and invited participants will all get connected to the same meeting based on this join link.

Reference is now made to FIG. 5. FIG. 5 illustrates a flow for a process 300 by which a user joins a meeting using the join link described above in connection with FIG. 4. Any user that is either the meeting organizer or a participant joins a meeting in this manner. The process 300 begins at 310 by a user clicking the join link (which has already been generated according to the operations described above in connection with FIG. 4). The join link may be displayed to a user in a calendar entry for a scheduled meeting. Once the user clicks on the join link, at 320, the operating system will activate the meeting client application in the user device. At 330, a connection is made to the server 30 and the meeting client application will dial, activate or otherwise use the join link to establish a communication session with the server 30. The meeting client application may be a web conference application, audio conference application, video conference endpoint client application, or any meeting client application of any technology type now known or hereinafter developed.

At 340, the server 30 uses the join link to find an already existing meeting (if this was not the first user to click a join link for this meeting) or generates and hosts a new meeting if this is the first user to click the join link. More specifically, when the first user to join a particular meeting clicks the join link, the server 30 will determine that it has not already started a particular meeting for a given join link, and will host the meeting for the first time. On the other hand, if the server receives a request with a join link to join a meeting that it has already started, the server will recognize the join link matches that for a meeting it has already hosted, and will connect the user into that meeting. Thus, the server stores data tracking join links to meeting instances so that it can determine whether a join request is for a meeting not yet set up and hosted, or for a meeting that has already started (hosted) because another user previously clicked the join link for that meeting.

In addition, at 340, the server 30 uses the type of meeting technology to host the meeting according to the meeting client application that first dialed the join link for the meeting. The join link is not tied to a particular meeting resource technology. When a user clicks the join link on his/her device, it could activate any meeting client type (of any technology) to join the meeting.

The examples presented herein include SIP and HTTP based virtual meetings. If join link client function creates both SIP and HTTP based links (possibly based on some type of configuration) for the same scheduled virtual meeting, the server 30 (and media orchestrator 60 shown in FIG. 1) would make sure all users for that meeting are connected the same meeting. For example, one user may be using a web conference client and another user may be using a telepresence endpoint on SIP). Said more generally, the server 30 may receive communications from each of a plurality of user devices using meeting join links of a different communication protocol but associated with the scheduled virtual meeting, and the server 30 connects the plurality of user devices into the same virtual meeting.

Furthermore, and with reference to FIG. 1, the server 30 can reside anywhere as long as the Domain Name Service (DNS) entries for it (in the domain of the join link generated by the join link client functions) point to the server 30. The join service functions could be split using split-DNS (different DNS response based on where the client is located) such that there is one join service function for on-premises users and another join service function for cloud users. The on-premises join service and the cloud join service could communicate in order to unify the meeting for presentation to the users.

To reiterate, meeting resources for the virtual meeting are not reserved/scheduled at the time the virtual meeting is scheduled. There is no need to choose the meeting resource technology to be used for the meeting at the time the meeting is scheduled. Furthermore, meeting links need not be distributed at the time the meeting is scheduled.

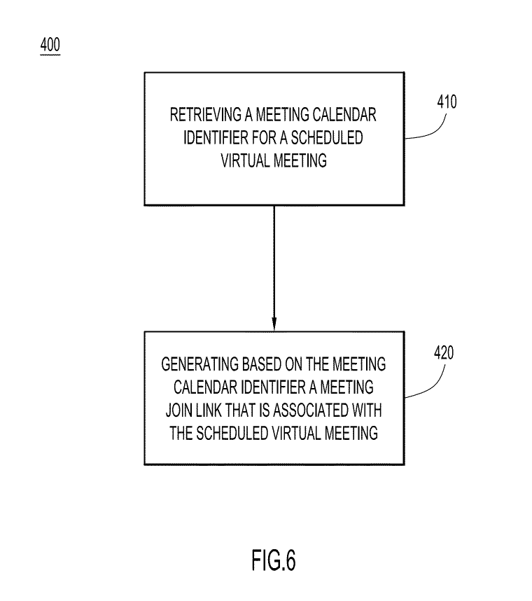

Reference is now made to FIG. 6. FIG. 6 is a flow chart depicting, at a high level, operations of a process 400 performed by a user device in accordance with example embodiments presented herein. These operations may be performed in a user device capable of scheduling a meeting or receiving an invitation for a meeting. At 410, a meeting calendar identifier is retrieved for a scheduled virtual meeting. At 420, based on the meeting calendar identifier, a meeting join link is (or multiple join links are) generated that is/are associated with the scheduled virtual meeting. As explained above, the meeting join link(s) may be generated based further on a meeting organizer identifier associated with the meeting organizer that scheduled the virtual meeting.

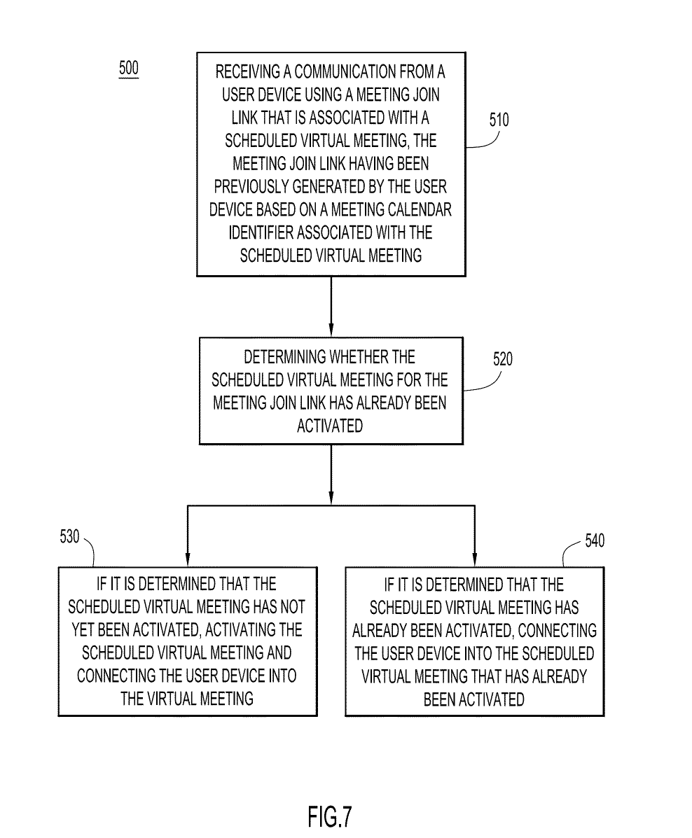

Turning now to FIG. 7, a flow chart is shown for operations of a process 500 performed by a server, e.g., server 30, in accordance with example embodiments presented herein. At 510, the server receives a communication from a user device, the communication made using a meeting join link that is associated with a scheduled virtual meeting, and the meeting join link having been previously generated by the user device based on a meeting calendar identifier associated with the scheduled virtual meeting. At 520, it is determined whether the scheduled virtual meeting for the meeting join link has already been activated (e.g., the meeting has been started). At 530, if the scheduled virtual meeting has not yet been activated, then it is activated and the user device is connected into the virtual meeting. On the other hand, at 540, if the scheduled virtual meeting has already been activated, then the user device is connected into the scheduled virtual meeting that has already been activated.

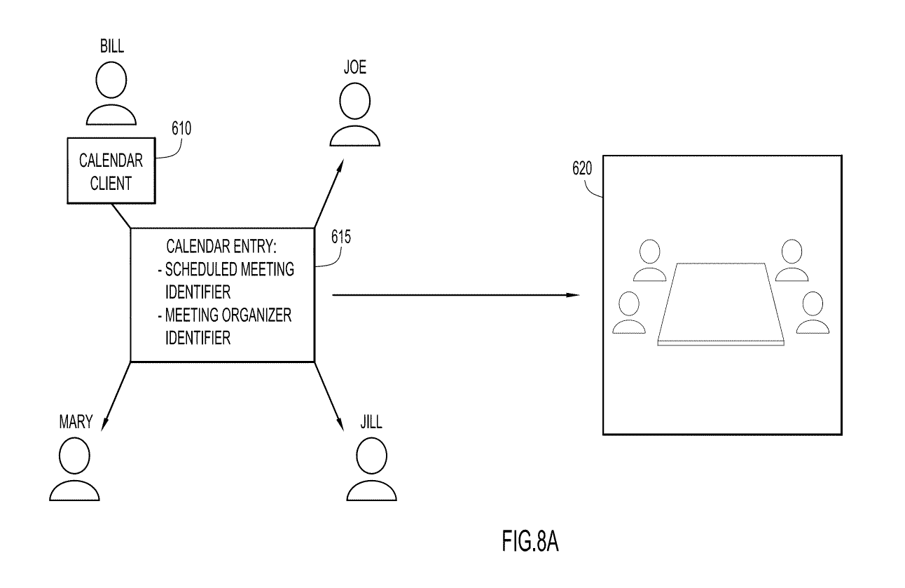

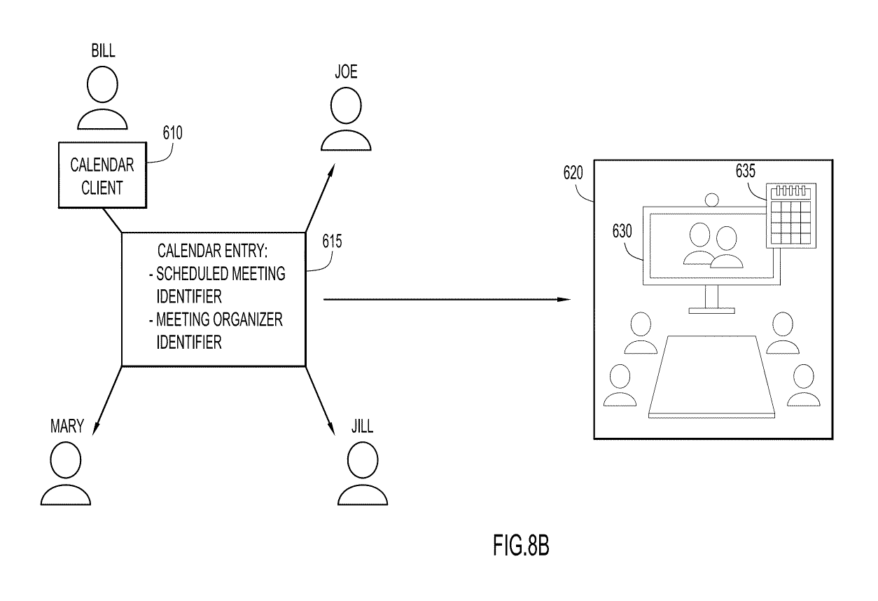

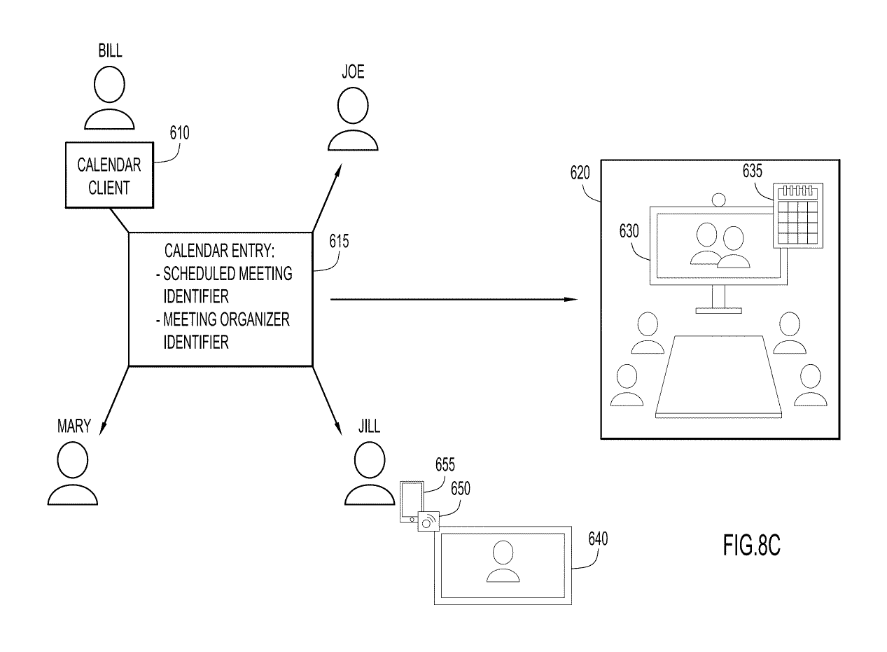

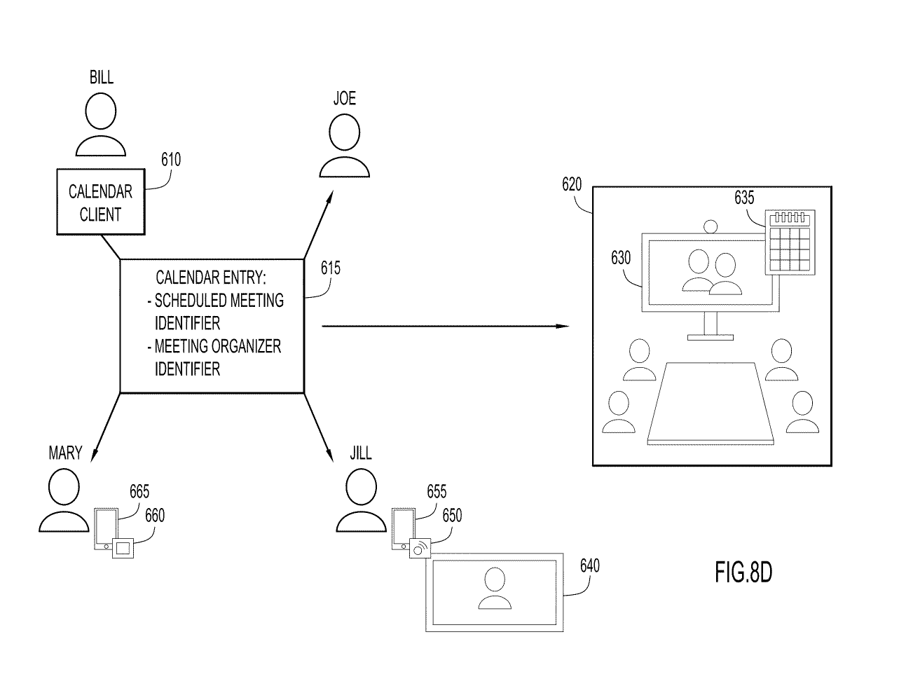

Reference is now made to FIGS. 8A-8D for an example of how the techniques presented above may be used in a real-world setting. In this example, there are four users: Bill, Joe, Mary and Jill. Bill is the meeting organizer and uses a calendar application 610 (e.g., Microsoft Outlook®) on a user device (e.g., laptop computer, desktop computer, tablet, SmartPhone, etc.) to schedule a meeting. In so doing, the calendar application 610 on Bill's device generates a calendar entry 615 that includes a scheduled meeting identifier (e.g., an iCal object) and a meeting organizer identifier. A meeting invitation including the information of the calendar entry is sent from Bill's calendar application 610 to the invited participant's Mary, Joe and Jill. The meeting invitation is also sent to a video conference endpoint in conference room shown at reference numeral 620. The meeting invitation does not specify any particular meeting technology for the scheduled meeting. As described above, a join link client function on the user devices for Bill, Joe, Mary and Jill reads the scheduled meeting identifier and meeting organizer identifier of the meeting invitation and can, at any time, generate the join link for the meeting that bill scheduled.

Reference is now made to FIG. 8B. In this example, Joe and Bill are local to the conference room 620 and walk into the room. There is a video conference endpoint 630 in the conference room 620. Since Bill sent the meeting invitation to the conference room 620, it is received by the video conference endpoint 630. There is a calendar application or meeting client application 635 running on the video conference endpoint 620. The application 635 includes the join link client function described above and automatically generates a join link for the meeting (using the technique described above) presents a join button icon on a touch screen at the scheduled meeting time. Either Joe or Bill can press the join button icon to join the meeting from the video conference endpoint 630.

Turning now to FIG. 8C, Jill finds a quiet room where a video conference endpoint 640 is located. Jill uses an application 650 (that is configured with the join link client function) on her mobile device 655. The application 655 is configured to control the video conference endpoint 640. The mobile devices 655 generates the join link for the meeting (through the operation of the application 655 equipped with the join link client function) and presents a join button on mobile device 655 that will cause the video conference endpoint 640 to join the meeting.

FIG. 8D shows that Mary is mobile and wants to join the meeting using a web conference/collaboration application 660 running on her mobile device 665. The application 660 is equipped with the join link client function and reads a calendar application on the mobile device 665, generates a join link and presents a join button for the meeting on Mary's mobile device 665 (within the application 660).

Without specifying any meeting technology in the meeting invitation, meeting clients of all types can have essentially the same join experience to the meeting. As long as a user device has the calendar entry and the join link client function capabilities, the user device can generate the join link and connect to the meeting.

In summary, in one form, a computer-implemented method is provided comprising: in a user device capable of scheduling a meeting or receiving an invitation to a meeting: retrieving a meeting calendar identifier for a scheduled virtual meeting; and generating based on the meeting calendar identifier a meeting join link that is associated with the scheduled virtual meeting.

In another form, a computer-implemented method is provided comprising: receiving a communication from a user device, the communication made using a meeting join link that is associated with a scheduled virtual meeting, the meeting join link having been previously generated by the user device based on a meeting calendar identifier associated with the scheduled virtual meeting; determining whether the scheduled virtual meeting for the meeting join link has already been activated; if it is determined that the scheduled virtual meeting has not yet been activated, activating the scheduled virtual meeting and connecting the user device into the scheduled virtual meeting; and if it is determined that the scheduled virtual meeting has already been activated, connecting the user device into the scheduled virtual meeting that has already been activated.

In still another form, a method is provided comprising: at each of a plurality of user devices capable of scheduling a meeting or receiving an invitation to a meeting: retrieving a meeting calendar identifier for a scheduled virtual meeting; and generating based on the meeting calendar identifier a meeting join link that is associated with the scheduled virtual meeting; at a server: receiving a communication from a particular user device of the plurality of user devices, the communication made using the meeting join link; determining whether the scheduled virtual meeting for the meeting join link has already been activated; if it is determined that the scheduled virtual meeting has not yet been activated, activating the scheduled virtual meeting and connecting the particular user device into the scheduled virtual meeting; and if it is determined that the scheduled virtual meeting has already been activated, connecting the particular user device into the scheduled virtual meeting that has already been activated.

In still another form, one or more non-transitory computer readable storage media are provided encoded with instructions that, when executed by a computer processor, cause the computer processor to perform operations comprising: retrieving a meeting calendar identifier for a scheduled virtual meeting; and generating based on the meeting calendar identifier a meeting join link that is associated with the scheduled virtual meeting.

In yet another form, an apparatus is provided comprising: a network interface unit that enables communication of a network; a memory; and a processor configured to: retrieve a meeting calendar identifier for a scheduled virtual meeting; and generate based on the meeting calendar identifier a meeting join link that is associated with the scheduled virtual meeting.

In still another form, one or more non-transitory computer readable storage media are provided encoded with instructions that, when executed by a computer processor, cause the computer processor to perform operations comprising: receiving a communication from a user device, the communication made using a meeting join link that is associated with a scheduled virtual meeting, the meeting join link having been previously generated by the user device based on a meeting calendar identifier associated with the scheduled virtual meeting; determining whether the scheduled virtual meeting for the meeting join link has already been activated; if it is determined that the scheduled virtual meeting has not yet been activated, activating the scheduled virtual meeting and connecting the user device into the scheduled virtual meeting; and if it is determined that the scheduled virtual meeting has already been activated, connecting the user device into the scheduled virtual meeting that has already been activated.

In still another form, an apparatus is provided comprising: a network interface unit that enables communication of a network; a memory; and a processor configured to: receive a communication from a user device, the communication made using a meeting join link that is associated with a scheduled virtual meeting, the meeting join link having been previously generated by the user device based on a meeting calendar identifier associated with the scheduled virtual meeting; determine whether the scheduled virtual meeting for the meeting join link has already been activated; if it is determined that the scheduled virtual meeting has not yet been activated, activate the scheduled virtual meeting and connecting the user device into the scheduled virtual meeting; and if it is determined that the scheduled virtual meeting has already been activated, connect the user device into the scheduled virtual meeting that has already been activated.

In still another form, a system is provided including a plurality of user devices capable of scheduling a meeting or receiving an invitation to a meeting, and a server. Each user device is configured to: retrieve a meeting calendar identifier for a scheduled virtual meeting; and generate based on the meeting calendar identifier a meeting join link that is associated with the scheduled virtual meeting. The server is configured to: receive a communication from a particular user device of the plurality of user devices, the communication made using the meeting join link; determine whether the scheduled virtual meeting for the meeting join link has already been activated; if it is determined that the scheduled virtual meeting has not yet been activated, activate the scheduled virtual meeting and connecting the particular user device into the scheduled virtual meeting; and if it is determined that the scheduled virtual meeting has already been activated, connect the particular user device into the scheduled virtual meeting that has already been activated.

Although the techniques are illustrated and described herein as embodied in one or more specific examples, it is nevertheless not intended to be limited to the details shown, since various modifications and structural changes may be made within the scope and range of equivalents of the claims.

What is claimed is:

1. A computer-implemented method comprising:
in a user device capable of scheduling a meeting or receiving an invitation to a meeting:
retrieving a meeting calendar identifier for a scheduled virtual meeting; and
generating based on the meeting calendar identifier a meeting join link that is associated with the scheduled virtual meeting.

2. The method of claim 1, wherein retrieving comprises retrieving a meeting organizer identifier associated with the scheduled virtual meeting, and generating is based further on the meeting organizer identifier.

3. The method of claim 1, further comprising the user device communicating with a server using the meeting join link to be connected by server to the virtual meeting that is associated with the meeting join link.

4. The method of claim 1, wherein the meeting join link is a Uniform Resource Identifier (URI) of any URI scheme.

5. The method of claim 4, wherein the meeting join link is a URI with a scheme for the Session Initiation Protocol (SIP).

6. The method of claim 4, wherein the meeting join link is a URI with a scheme for the Hypertext Transport Protocol (HTTP).

7. The method of claim 4, wherein the meeting join link is a URI with a scheme for the Hypertext Transport Protocol Secure (HTTPS).

8. The method of claim 1, wherein the meeting calendar identifier is an identifier compliant with the iCalendar standard of RFC 5545.

9. The method of claim 1, wherein the generating is performed using a predetermined procedure on each of a plurality of user devices that are to participate in the scheduled virtual meeting using the meeting calendar identifier for the scheduled virtual meeting so that each of the plurality of user devices can generate the same one or more meeting join links associated with the scheduled virtual meeting using the predetermined procedure.

10. The method of claim 1, wherein generating comprises generating a plurality of meeting join links each associated with the scheduled virtual meeting, each of the plurality of meeting join links for a different communication protocol by which the scheduled virtual meeting can be joined.

11. A method comprising:
at each of a plurality of user devices capable of scheduling a meeting or receiving an invitation to a meeting:
retrieving a meeting calendar identifier for a scheduled virtual meeting; and
generating based on the meeting calendar identifier a meeting join link that is associated with the scheduled virtual meeting;
at a server:
receiving a communication from a particular user device of the plurality of user devices, the communication made using the meeting join link;
determining whether the scheduled virtual meeting for the meeting join link has already been activated;
if it is determined that the scheduled virtual meeting has not yet been activated, activating the scheduled virtual meeting and connecting the particular user device into the scheduled virtual meeting; and
if it is determined that the scheduled virtual meeting has already been activated, connecting the particular user device into the scheduled virtual meeting that has already been activated.

12. The method of claim 11, wherein the generating is performed using a predetermined procedure on each of the plurality of user devices that are to participate in the scheduled virtual meeting using the meeting calendar identifier for the scheduled virtual meeting so that each of the plurality of user devices can generate the same one or more meeting join links associated with the scheduled virtual meeting using the predetermined procedure.

13. The method of claim 11, wherein retrieving further comprises retrieving a meeting organizer identifier associated with the scheduled virtual meeting, and generating is based further on the meeting organizer identifier.

14. The method of claim 11, wherein the meeting join link includes is a Uniform Resource Identifier (URI) of any URI scheme.

15. The method of claim 11, wherein the meeting join link points to a domain of the server.

16. The method of claim 11, wherein the meeting join link points to a domain associated with an email address of a meeting organizer associated with the scheduled virtual meeting.

17. The method of claim 11, wherein generating comprises generating a plurality of meeting join links each associated with the scheduled virtual meeting, each of the plurality of meeting join links for a different communication protocol by which the scheduled virtual meeting can be joined.

18. A computer-implemented method comprising:
receiving a communication from a user device, the communication made using a meeting join link that is associated with a scheduled virtual meeting, the meeting join link having been previously generated by the user device based on a meeting calendar identifier associated with the scheduled virtual meeting;
determining whether the scheduled virtual meeting for the meeting join link has already been activated;
if it is determined that the scheduled virtual meeting has not yet been activated, activating the scheduled virtual meeting and connecting the user device into the scheduled virtual meeting; and
if it is determined that the scheduled virtual meeting has already been activated, connecting the user device into the scheduled virtual meeting that has already been activated.

19. The method of claim 18, wherein the meeting join link is a Uniform Resource Identifier (URI) of any URI scheme.

20. The method of claim 18, wherein receiving comprises receiving a communication from each of a plurality of user devices each using the same one or more meeting join links for the scheduled virtual meeting and having been separately previously generated by the respective user devices based on the meeting calendar identifier of the scheduled virtual meeting.

21. The method of claim 18, wherein receiving comprises receiving communications from each of a plurality of user devices using meeting join links of a different communication protocol but associated with the scheduled virtual meeting, and further comprising connecting the plurality of user devices into the same virtual meeting.

22. One or more non-transitory computer readable storage media encoded with instructions that, when executed by a computer processor, cause the computer processor to perform operations comprising:
retrieving a meeting calendar identifier for a scheduled virtual meeting; and
generating based on the meeting calendar identifier a meeting join link that is associated with the scheduled virtual meeting.

23. The non-transitory computer readable storage media of claim 22, wherein the instructions for retrieving include instructions for retrieving a meeting organizer identifier associated with the scheduled virtual meeting, and the instructions for generating the meeting join link are based further on the meeting organizer identifier.

24. The non-transitory computer readable storage media of claim 22, further comprising instructions for communicating with a server using the meeting join link to be connected by the server to the virtual meeting that is associated with the meeting join link.

25. The non-transitory computer readable storage media of claim 22, wherein the meeting join link is a Uniform Resource Identifier (URI) of any URI scheme.
